(19) United States
(12) Patent Application Publication
(10) Pub. No.: US 2023/0412010 A1
(43) Pub. Date: Dec. 21, 2023

(54) METHOD FOR PRODUCING A ROTOR ELEMENT FOR A ROTOR OF AN ELECTRIC MACHINE, ROTOR ELEMENT, ROTOR, ELECTRIC MACHINE AND MOTOR VEHICLE

(71) Applicant: Ford Global Technologies, LLC, Dearborn, MI (US)

(72) Inventors: Raphael Koch, Odenthal (DE); Wanfeng Li, Novi, MI (US)

(73) Assignee: Ford Global Technologies, LLC, Dearborn, MI (US)

(21) Appl. No.: 18/336,662

(22) Filed: Jun. 16, 2023

(30) Foreign Application Priority Data
Jun. 17, 2022 (DE) 102022115198.0

(51) Int. Cl. H02K 1/02; H02K 15/02; B33Y 80/00

(52) U.S. Cl. CPC H02K 1/02; H02K 15/02; B33Y 80/00; B33Y 10/00

(57) ABSTRACT

The disclosure relates to a method for producing a rotor element for a rotor of an electric machine. The method includes screen printing at least one permanent magnetic material and a non-permanent magnetic material to form the rotor element, simultaneously sintering the permanent magnetic material and the non-permanent magnetic material, and magnetizing the permanent magnetic material.

### CROSS-REFERENCE TO RELATED APPLICATION

This application claims priority to and the benefit of German Patent Application No. 102022115198.0, filed on Jun. 17, 2022. The disclosure of the above application is incorporated herein by reference.

### FIELD

The disclosure relates to a method for producing a rotor element for a rotor of an electric machine, a rotor element and a rotor having such rotor elements, an electric machine, and a motor vehicle having such an electric machine.

### BACKGROUND

The statements in this section merely provide background information related to the present disclosure and may not constitute prior art.

Motor vehicles, such as passenger cars, for example, can have a drive train with at least one electric machine, which can be operated at least temporarily as a motor and then serves as a traction motor. In other words, the motor vehicle may be a purely electric vehicle (BEV—battery electric vehicle) or a hybrid electric vehicle (HEV).

In order to increase the range of such motor vehicles, any enhancement of the electric machine is important. Moreover, it would help to reduce the budgets for the battery. Furthermore, installation space restrictions are an important factor in development. If, for example, the efficiency, torque or power density of an electric machine are to be enhanced, a soft magnetic high-performance material with a high silicon content (e.g. 6% Si) or materials such as iron-cobalt (FeCo) should be used. However, such alloys are difficult to process by conventional techniques. For this reason, they are currently used only in electric machines for the aerospace industry.

In addition, the use of rare earths for permanent magnets is difficult for reasons of environmental protection, supply chain and budget.

Hard magnetic materials (permanent magnets) have very high coercive field strengths and accordingly offer a high resistance to external magnetic fields. Remagnetization (or demagnetization) is achieved only with very strong external fields. Soft magnetic materials, on the other hand, also referred to as non-permanent magnets, are characterized by easy magnetizability, which is reflected in a small coercive force. The coercive field strength Hc used as a common classification criterion for magnetic materials is that field strength at which the induction (polarization) remaining from magnetization disappears again. In a hysteresis loop, Hc represents the passage through the X axis of the field strength H. The boundary between the two material groups is approximately Hc=1 kA/m.

Methods for producing a rotor element for a rotor of an electric machine are known from US 2013/0076193 A1, DE 10 2016 102 386 A1, U.S. Pat. Nos. 7,399,368 B2, 8,508,092 B2 and 11,075,568 B2.

### SUMMARY

This section provides a general summary of the disclosure and is not a comprehensive disclosure of its full scope or all of its features.

The present disclosure provides a method for producing a rotor element for a rotor of an electric machine, comprising the following steps:
screen printing at least one hard magnetic material and a soft magnetic material to form the rotor element,
simultaneously sintering the hard magnetic material and the soft magnetic material, and
magnetizing the hard magnetic material.

Here, screen printing is understood to mean a printing method in which a printing medium, for example in liquid or pasty form or in powder form, is printed through a fine-mesh fabric onto a material to be printed. In this case, regions of the hard magnetic material can be surrounded by regions of the soft magnetic material. In other words, a region of the hard magnetic material is embedded in a region of the soft magnetic material.

Sintering is understood to mean that, for example, metallic materials are heated, but the temperatures remain below the melting temperature of the main components, thus ensuring that the configuration (shape) of a workpiece or blank is substantially retained. In this context, the term substantially is understood to mean within manufacturing-related tolerances.

The efficiency of an electric machine having a rotor with such rotor elements is increased in that the eddy current losses in the magnets formed by the hard magnetic material and the soft magnetic material are reduced because they form segmented structures. The loss reduction can be up to 30 W at 6000 rpm with a sinusoidal current profile. In the case of pulse-width-modulated waveforms, the loss reduction will be even higher, particularly at higher rotational speeds. Efficiency can be increased even further since it is possible to use materials such as Fe-6.5Si (steel containing 6.5 wt % Si) that cannot be processed by punching.

Since the hard magnetic material and the soft magnetic material are metallically connected to one another, the mechanical strength of the rotor is increased. Therefore, the rotational speed of the rotor can be increased.

Furthermore, the magnets formed by the hard magnetic material and the soft magnetic material can be placed very close to the outer circumference of the rotor.

According to one form, the hard magnetic material forms at least one permanent magnet having a corner-free basic shape. Thus, the hard magnetic material can have basic shapes which are different from known rectangular or square basic shapes. Corner-free basic shapes can be round or oval basic shapes but also S-shaped basic shapes, or lens-shaped basic shapes, such as meniscus-shaped basic shapes, or concave or convex shapes. By means of such a configuration, the available installation space can be better utilized and flux guidance in the interior of the rotor can be optimized.

According to a further form, at least one passage extending in the axial direction of the rotor is formed. Such a passage is also referred to as a flux barrier. Such flux barriers can be arranged, for example, in the vicinity of the permanent magnets formed by the hard magnetic material in order to obtain a specific flux path after magnetization. In this way, a further increase in efficiency can be achieved. The passage can also be used to selectively introduce a magnetic pole at this point for the magnetization process. This can have a positive effect on flux guidance in the interior of the rotor and thus also in the magnets formed and hence likewise contribute to an increase in efficiency.

According to a further form, the hard magnetic material contains neodymium-iron-boron (NdFeB) and/or the soft magnetic material contains iron-silicon (FeSi) and/or iron-cobalt (FeCo), and the sintering is carried out at a temperature in the range of from 1200° C. to 1300° C. Iron-silicon (FeSi) is understood to mean inorganic chemical compounds of iron and silicon such as Si₃Fe, while neodymium-iron-boron is understood to mean an alloy of neodymium, iron and boron, e.g. with the composition Nd₂Fe₁₄B, from which as a material the currently strongest permanent magnets are produced. In this way, it is possible to achieve simultaneous sintering of the hard magnetic material and of the soft magnetic material with, at the same time, a shrinkage rate which is unproblematic.

The disclosure also includes a rotor element and a rotor having such rotor elements, an electric machine and a motor vehicle having such an electric machine.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a schematic illustration of a rotor element for a rotor of an electric machine with an enlarged detail;

FIG. 2 shows a schematic illustration of various examples of corner-free basic shapes; and

FIG. 3 shows a schematic illustration of a method sequence for producing the rotor element shown in FIG. 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

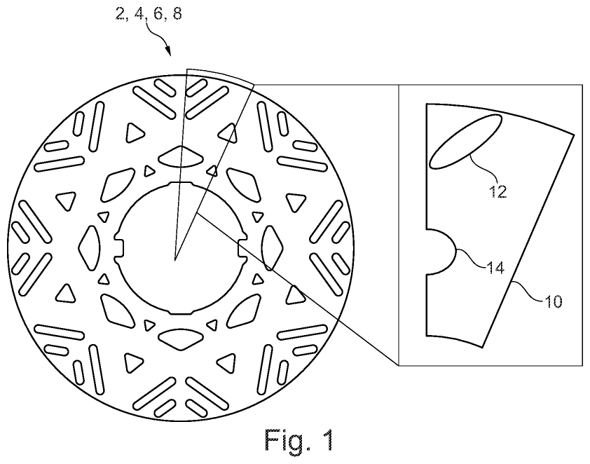

Reference is made first of all to FIG. 1.

A rotor element 8 for a rotor 6 of an electric machine 4 is illustrated. In the present exemplary form, the electric machine 4 is assigned to a drive train of a motor vehicle 2, such as, for example, a passenger car, which can be operated at least temporarily as a motor and then serves as a traction motor. In other words, the motor vehicle 2 may be a purely electric vehicle (BEV—battery electric vehicle) or a hybrid electric vehicle (HEV).

In the present exemplary form, the electric machine 4, such as a PMSM machine, is a rotary machine having the rotor 6 and a stator (not illustrated). In the present exemplary form, the rotor 6 is designed as an internal rotor. As a departure from the present exemplary form, the rotor 6 can also be designed as an external rotor.

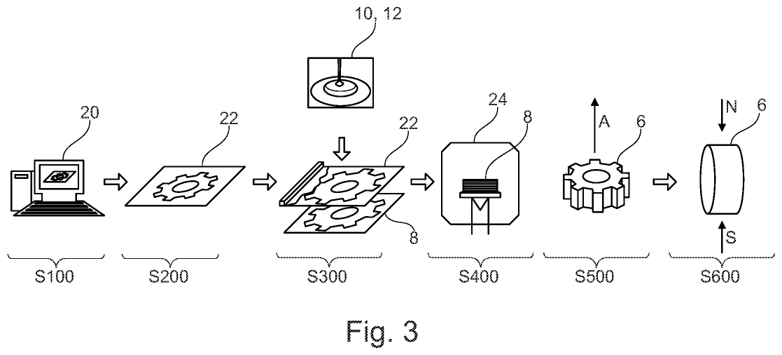

In the present exemplary form, the rotor element 8 is a substantially disk-shaped element, wherein a plurality of rotor elements 8 stacked one on top of the other form the rotor 6. In other words, a plurality of rotor elements 8 is arranged one on top of the other in the axial direction A (see FIG. 3) of the rotor 6, wherein the axial direction A is at the same time the axis of rotation of the rotor 6.

In the present exemplary form, the rotor element 8 has a plurality of sections of a screen-printed and simultaneously sintered and then magnetized hard magnetic material 12. In this case, the sections of the hard magnetic material 12 are embedded in a section or base body with a substantially disk-shaped basic shape corresponding to the rotor element 8.

In the present exemplary form, the hard magnetic material 12 contains neodymium-iron-boron, for example Nd₂Fe₁₄B, and the soft magnetic material 10 contains iron-silicon, for example Fe₃Si, or iron-cobalt (FeCo). The hard magnetic material 12 as well as the soft magnetic material 10 were sintered at a temperature in the range of from 1200° C. to 1300° C. after having been applied by screen printing.

Furthermore, in the present exemplary form, the rotor element 8 has a passage 14 extending in the axial direction A of the rotor 6.

In the present exemplary form, the hard magnetic material 12 in each case has an oval basic shape.

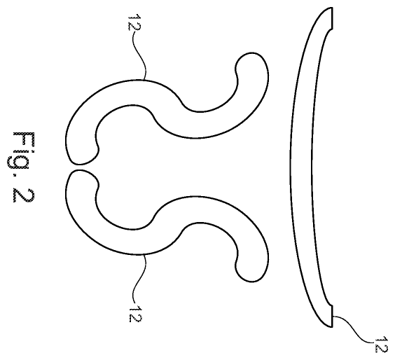

Reference is now additionally made to FIG. 2.

Further examples of a corner-free basic shape, such as a lens-shaped basic shape, are illustrated. A meniscus-shaped basic shape is illustrated. As a departure from this, the basic shape can also be concave or convex. As a further example of a corner-free basic shape, an S-shaped basic shape is illustrated.

Reference is now additionally made to FIG. 3 in order to explain further details of the method for producing the rotor element 8 for the rotor 6 of the electric machine 4.

In a first step S100, a layout for a screen 22 for screen printing is created on a PC 20 in a CAD or CAE environment.

In a further step S200, the screen 22 is produced according to the layout determined in the first step.

In a further step S300, the rotor element 8 is produced by applying the hard magnetic material 12 and the soft magnetic material 10 by means of screen printing, wherein in the present exemplary form the hard magnetic material 12 and the soft magnetic material 10 are in each case in the form of a suspension and are in each case also applied in the form of a suspension.

In a further step S400, the hard magnetic material 12 and the soft magnetic material 10 of the green part (blank) for the rotor 6 are sintered in a sintering furnace 24.

In a further step S500, a plurality of sintered blanks, i.e. lamellae or sheets, are arranged one above the other along the axial direction A in order to form the rotor 6.

In a further, optional step S600, the hard magnetic material 12 of the rotor 6 is magnetized in order to form permanent magnets in these regions and to finish it.

As a departure from the present exemplary form, the sequence of the steps may also be different. Furthermore, a plurality of steps can also be carried out at the same time or simultaneously. Furthermore, as a departure from the present exemplary form, individual steps can also be skipped or omitted.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for producing a rotor element for a rotor of an electric machine, the method comprising:
screen printing at least one permanent magnetic material and a non-permanent magnetic material to form the rotor element;
simultaneously sintering the permanent magnetic material and the non-permanent magnetic material; and
magnetizing the permanent magnetic material.

2. The method according to claim 1, wherein the permanent magnetic material forms at least one permanent magnet having a corner-free basic shape.

3. The method according to claim 1, wherein at least one passage extending in an axial direction of the rotor is formed.

4. The method according to claim 1, wherein the permanent magnetic material contains neodymium-iron-boron, and the sintering is carried out at a temperature in the range of from 1200° C. to 1300° C.

5. The method according to claim 1, wherein the non-permanent magnetic material contains iron-silicon, and the sintering is carried out at a temperature in the range of from 1200° C. to 1300° C.

6. The method according to claim 1, wherein the non-permanent magnetic material contains iron-cobalt, and the sintering is carried out at a temperature in the range of from 1200° C. to 1300° C.

7. A rotor element for a rotor of an electric machine, the rotor element having at least one permanent magnetic material, the at least one permanent magnetic material being screen printed and simultaneously sintered and then magnetized.

8. The rotor element according to claim 7, wherein the permanent magnetic material is at least one permanent magnet having a corner-free basic shape.

9. The rotor element according to claim 7, wherein at least one passage extending in an axial direction of the rotor is provided.

10. The rotor element according to claim 7, wherein the permanent magnetic material contains neodymium-iron-boron, and the sintering is carried out at a temperature in the range of from 1200° C. to 1300° C.

11. The rotor element according to claim 7, wherein the non-permanent magnetic material contains iron-silicon, and the sintering is carried out at a temperature in the range of from 1200° C. to 1300° C.

12. The rotor element according to claim 7, wherein the non-permanent magnetic material contains iron-cobalt, and the sintering is carried out at a temperature in the range of from 1200° C. to 1300° C.

13. A rotor having a rotor element according to claim 7.

14. An electric machine having a rotor according to claim 9.

15. A motor vehicle having an electric machine according to claim 10.
